(19) United States
(12) Patent Application Publication
(10) Pub. No.: US 2021/0131462 A1
(43) Pub. Date: May 6, 2021

(54) SECUREMENT DEVICE FOR STONE AND STONE-LIKE SLABS

(71) Applicant: William Gerard, Lexington, KY (US)

(72) Inventor: William Gerard, Lexington, KY (US)

(21) Appl. No.: 16/672,031

(22) Filed: Nov. 1, 2019

(51) Int. Cl. F16B 2/06; B65D 67/02

(52) U.S. Cl. CPC F16B 2/065; B65D 67/02

(57) ABSTRACT

A device and method for securing stone or stone-like slabs especially during transport, storage, and/or other stoppages, the device including opposing first and second jaws configured for being in a non-permanent engagement with one another in a plurality of positions, wherein each position defines a lateral or axial extent of a material receiving zone, the first jaw including a pivotally adjustable material contacting member configured for transverse movement relative to the lateral extent of the material receiving zone and the second jaw including a material contacting member configured for lateral movement within the material receiving zone opposing the pivotally adjustable material contacting member.

### FIELD OF THE INVENTION

The present invention relates to a securement device for stone and stone-like slabs, and is more specifically directed to a device for securing such slabs during transport, storage, or other stoppages.

### BACKGROUND OF THE INVENTION

Stone and stone-like slabs are used for a variety of purposes including serving as kitchen countertops or other working surfaces, as well as serving as decorative and/or functional building material for walls and other surfaces. Such stone or stone-like slabs are often composed of relatively heavy cut slabs of natural stone such as marble, granite, or quartz; other natural material such as wood; or manufactured materials such as concrete, formica, or, other reasonable substitutes for stone such as plastic (laminates) including but not limited to acrylics, epoxies, or phenolic resins. Such slabs are often given a general to near-final form at or near locations where appropriate raw material is readily available (e.g., a rock quarry or timber processing operation) for natural material; or at or near the point of manufacture (e.g., a production plant) for artificial material. Then the slabs are often transported to temporary storage, before often being eventually transported to (the vicinity of) an eventual installation/usage site (e.g., a private residence or public building being constructed/remodeled/updated).

Often it is not desirable to transport, store, or otherwise maintain single/stacked slabs with their shortest physical dimension oriented vertically, as vertically oriented gravity-induced stresses would generally be strongest across the thinnest, generally weakest, cross-section of said slab(s). Such gravity-induced (and other) stressors during transport/storage operations can result in costly breakage and/or cracking of the slabs thereby diminishing the slabs' decorative/functional utility. But, it is often not desirable to transport, store, or maintain one or more associated slabs with their shortest physical dimension orientated horizontally, as they would be more likely to tip over during transport, potentially damaging equipment and injuring people. And it is often not desirable to transport, store, or maintain one or more associated slabs with their largest area faces forming too large of an angle from vertical as the slabs would have a tendency to slip and/or otherwise fall thereby placing the slab in a state of lowered kinetic energy with regard to its immediate environment. So single/stacked slabs are often transported/stored/maintained with a larger side surface leaning generally not more than 15 degrees from vertical against a half A-frame or A-frame slab rack having spaced similarly slanted members that functionally forming the equivalent of an angled bed for the slab(s) to lean upon; thereby hopefully minimizing gravity-induced breakage without unduly risking the slabs tipping, slipping, and/or otherwise falling. Sometimes, two half A-frame or an A-frame slab rack will be mounted upon and/or form part of the sturdy support bed of a stone slab transport vehicle.

Stone and stone-like slab(s) leaning upon a half A-frame, or A-frame slab rack need to be secured during transport to their installation point, as well as during other periods such as during local transport operations arounds points of manufacture/storage/installation, storage, and/or other stoppages.

Various systems exist for securing stone and stone-like slabs during transport, storage, and/or other stoppages. One common method utilizes ratchet/friction straps to lash down one or more slabs to the transport vehicle, half A-frame rack, A-frame rack, and/or each other. However, such lashing operations can be costly and time-consuming in terms of preparation, execution, clean up, and equipment replacement. Another system utilizes mounted parallel sets of toothed bars/rails extending out from the A-frame rack under and beyond loaded slabs looking much like the linear gear of a rack and pinion system, said method includes braces with one end that can be inserted in an appropriate space between teeth of the toothed bar/rail [the particular space between teeth being chosen based upon the thickness of the slab load being transported] while the other end of the brace is attached above the slab to the half A-frame or A-frame rack. But said equipment can be expensive, heavy, and frequently requires replacement when either the brace, toothed bar/rail, or the (half) A-frame are damaged during loading and unloading operations. Also, the teeth of toothed bars/rails are generally spaced in discrete intervals making securing quality less than ideal particularly in the absence of additional appropriate space-filling material to wedge between the otherwise empty space between the brace and slab(s), with the slab(s) potentially being able to move around enough during transport operations to damage slab edges/surfaces against (among other things) braces, toothed bar(s)/rail(s), and/or the A-frame. Also, such a less than ideally secured slab will have a tendency to be gravitationally/inertially moved during transport, potentially resulting in breakage, cracking, or scratches and/or potentially hazardous load shifting.

Proper securement of transported and stored slabs is very important for safety reasons. Stone and stone-like slab can be exceedingly heavy and a United States governmental occupational safety agency has issued warning communications regarding the dangers of crush injuries/deaths to workers in the pertinent industries. For example, an Aug. 12, 2008 United States Department of Labor Safety and Health Information Bulletin was issued by the Occupational Safety and Health Administration (“OSHA”) entitled “Hazards of Transporting, Unloading, Storing and Handling Granite, Marble and Stone Slabs”.

Accordingly, for the above reasons and others, there is a need in the stone and stone-like slab industry for alternate and/or additional devices for securing of stone or stone-like slabs, particularly during transport, storage, and other stoppages

### SUMMARY OF THE INVENTION

The invention is generally directed to systems and methods which address the issues cited above as well as other issues.

Embodiments of the invention are generally directed to a securing device for stone or stone-like slabs including a securement frame structure having a first end section including a curved retaining bracket to wrap around some portion of a half A-frame rack, A-frame rack, or other similar support structure; and an essentially opposing second end section including an adjusting screw mechanism to help force/maintain the securing device for stone and stone-like slabs, as well as one or more slabs, proximal to a half A-frame, A-frame rack, or other similar support structure.

In some embodiments, the securement frame structure has a general overall appearance/structure similar to a G-clamp (with additional elements/limitations) having first and second end sections connected by a middle section with distinct deformation bends (i.e., corners) between the first end section and middle section as well as between the second end section and middle section; however, other general appearances/structures (e.g., a bowed general semi-circle) are possible provided that the securement frame structure is configurable to have an open face allowing the securing device for stone or stone-like slabs to be fitted over/around some portion of a slab load as well as some portion of a half A-frame, A-frame, or other similar support structure.

In an exemplary embodiment the securement frame structure is comprised of first and second frame halves configurable between an attached mode in which the first and second frame halves are functionally attached to (and overlap with) one another preferably at (and while helping to form) a middle section of the securement frame structure; and a detached mode in which the first and second frame halves are functionally detached from one another. Functional attachment or detachment relates respectively to configurations intended or not intended to be used while securing stone or stone-like slabs, and does not include secondary reasons for potential attachment/detachment such as incidental attachment by a chain, rope, etc. for the purpose of keeping two parts in the same general vicinity of one another to ensure the availability of matched parts at the time of desire usage.

In an exemplary embodiment, an insertion terminus of the second frame half is configurable for insertion into a slot defined by a receiving terminus of the first frame half thereby helping to join the two frame halves thereby forming the overall securement frame structure.

In an exemplary embodiment the exact positioning of the two joinable frame halves in relation to one another is adjustable via usage of a lynchpin insertable through alignable holes defined by overlappable portions of joined frame halves. Preferably, the lynchpin retained with aligned holes by a cotter pin engageable with apertures defined by the lynchpin.

In an exemplary embodiment the first end section formed by the first frame half includes a curved retaining bracket configurable to fit over some portion of a half A-frame, A-frame, or other similar support structure; while the second end section formed by the second frame half includes a screw mechanism for transitioning between a closed mode in which the securing device and slabs are forced/maintained proximal to a half A-frame, A-frame, or other similar support structure, and an open mode in which the securing device may be more easily adjusted and/or initially fitted over or removed from the slab(s) and an associated support structure (i.e., half A-frame, A-frame, or other similar support structures.

In an exemplary embodiment the curved retaining bracket is configurable to swivel upon a first threaded rod, said threaded rod being integrally attached to the first end section; the curved retaining bracket preferably being retained upon the threaded rod by a wing nut configurable to tighten the curved retaining bracket to the first end section once the swivelable retaining bracket is in a desirable position.

In an exemplary embodiment, the screw mechanism is comprised of a distal handle attached to a second threaded rod, said threaded rod extending through a threaded nut aligned with a hole defined by the second end section to proximally engage a fixed ball head joint seated within a flanged saucer-shaped jaw initially defining an open face. Preferably, said open face is at least partially filled by buffering material extending beyond the open face, said flanged saucer-shaped jaw and buffering configurable to be adjusted via the fixed ball head joint to engage stone and stone-like slabs leaning against a half A-frame, A-frame, or other similar support structure when the handle is turned thereby axially adjusting the second threaded rod to move the securing device for stone or stone-like slabs from a non-engaged mode to an engaged mode.

Other embodiments of the invention are directed to a securing device comprising: first and second jaw members in a non-permanent engagement with one another, wherein the engagement is enabled for adjustment of the first and second jaw members in a plurality of positions, each position defining a lateral extent of a material receiving zone between the first and second jaw members; a first material contacting member pivotally mounted on the first jaw member, wherein the material contacting member includes one or more material contacting surfaces configured to move in a transverse position relative to the lateral extent of the material receiving zone; and a second material contacting member mounted on the second jaw member, wherein the material contacting member includes one or more material contacting surfaces configured to move in a lateral position within the material receiving zone.

### BRIEF DESCRIPTION OF THE DRAWINGS

Various aspects of the present invention are illustrated by way of example, and not by way of limitation, in the accompanying drawings, wherein;

FIG. 1 is a first perspective schematic view of the elements of a material securing device constructed in accordance with an embodiment of the invention;

FIG. 2 is a second perspective schematic view of the material securing device of FIG. 1;

FIG. 3 is a front schematic view of the material securing device of FIG. 1;

FIG. 4 is a perspective view of the material securing device of FIG. 1 illustrating the elements of the device in an engaged condition; and

FIG. 5 is a perspective view of the material securing device of FIG. 1 illustrating the device in the engaged condition in operation to secure sheets of material.

### DETAILED DESCRIPTION OF THE INVENTION

The detailed description set forth below in connection with the appended drawings is intended as a description of various embodiments of the invention along with practical or advantageous uses thereof, but is not intended to represent the only embodiments or uses in which the invention may be practiced. The detailed description includes specific details for the purpose of providing a thorough understanding of the invention and in some instances may not include specific details of what is believed to be known features and elements may be shown or mentioned with an abbreviated description in order to avoid obscuring concepts of the invention. However, such known features and elements are believed to be apparent to those skilled in the art, and it should be further apparent to those skilled in the art that the invention may be practiced without all of the specific details and such known features and elements.

The following description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by this application. Moreover, nothing disclosed herein is intended to be dedicated to the public regardless of whether such disclosure is explicitly recited in any claim(s). No claim element is to be construed under the provisions of 35 U.S.C. § 112, sixth paragraph, unless the element is expressly recited using the phrase “means for” or, in the case of a method claim, the element is recited using the phrase “step for.”

As will be appreciated by one skilled in the art(s), aspects of the present invention may be embodied as a method, system, or structure. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

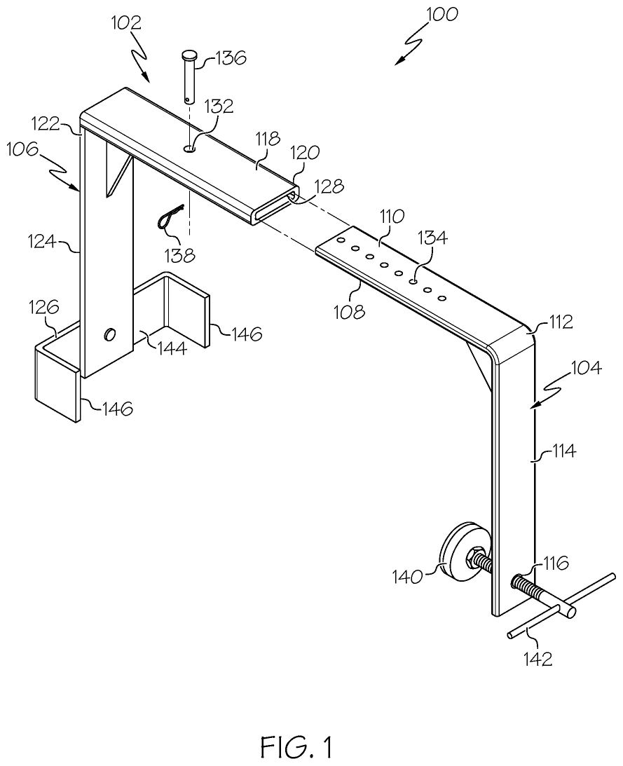

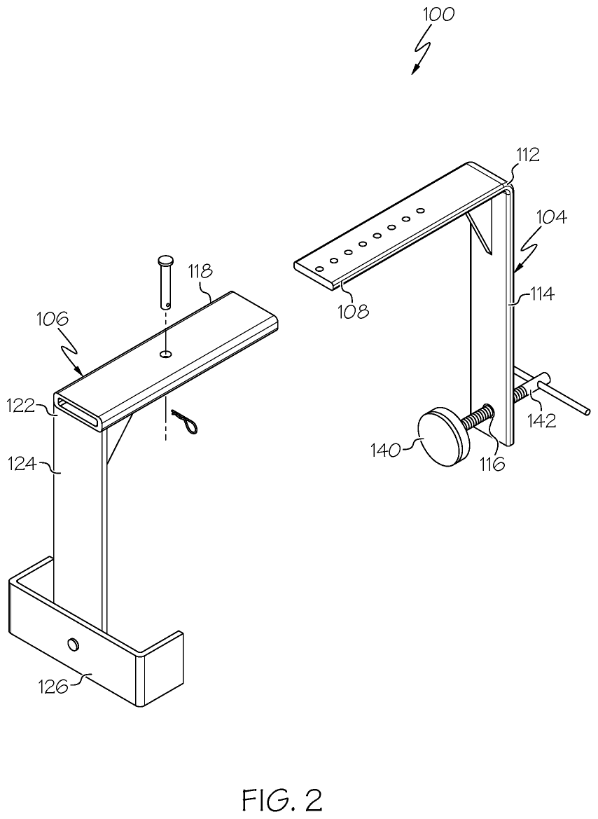

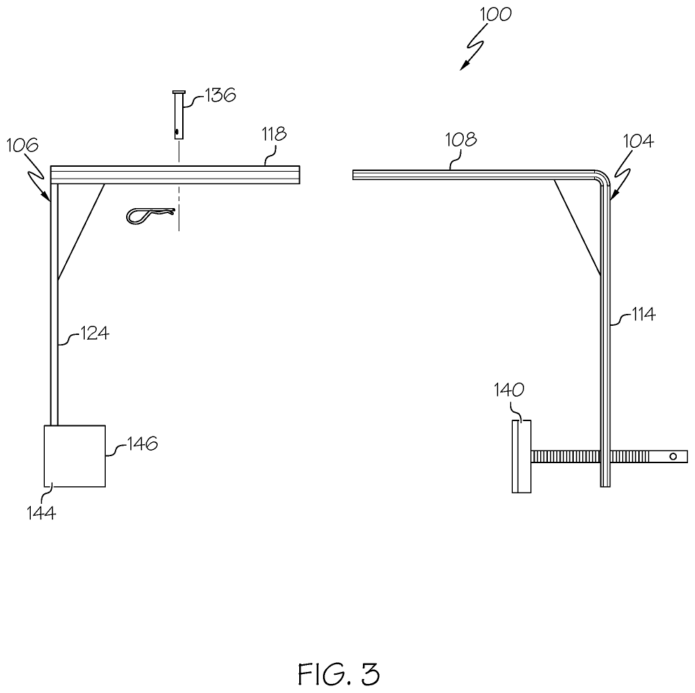

FIG. 1 through FIG. 5 depict a material securing device 100 constructed in accordance with the invention generally comprising a frame 102 composed of a first jaw member 104 and an opposing second jaw member 106. Jaw member 104 and jaw member 106 are adapted and configured to be in a laterally adjustable, non-permanent engagement with one another and a material receiving zone, wherein jaw members 104 and 106 (or jaws 104 and 106) each include material contacts that can be adjusted to secure material within the material receiving zone.

In this embodiment, jaw 104 is generally L-shaped with a first arm 108 defining an elongated neck 110 adjoining an elbow portion 112 which is further adjoined to a second arm 114 including a first material contact assembly 116. Jaw 106 of this embodiment is also generally L-shaped with a first arm 118 including an elongated sleeve 120 adjoining an elbow portion 122 which is further adjoined to a second arm 124 including a second material contact assembly 126. Elbow portions 112 and/or 122 may include a gusset for reinforcement.

Sleeve 120 defines a channel 128 for receiving neck 110 therein thus connecting first jaw 104 and second jaw 106 to one other at first arm 108 and first arm 118, respectively, and forming a material receiving zone 130 defined laterally between respective second arms 114 and 124. First arm 108 and first arm 118 may be further engaged with one another through any conventional adjustable fastening means.

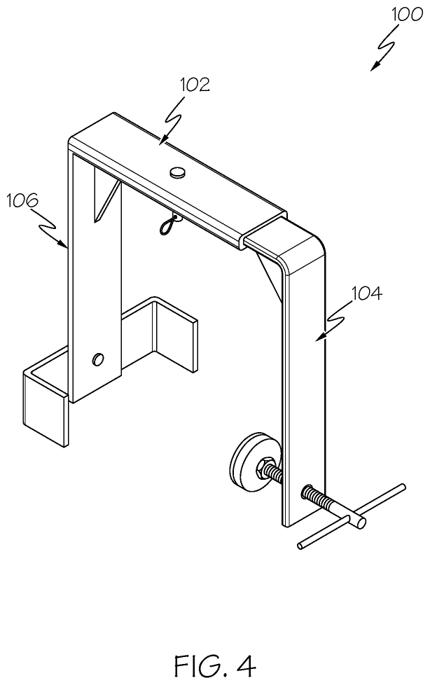

In this embodiment, sleeve 120 includes an opening 132 and neck 110 includes openings 134 which enable first arm 108 and first arm 118 to be engaged with one another via clevis pin 136 and hitch pin 138. Inserting clevis pin 136 through opening 132 and openings 134 and securing with hitch pin 138 advantageously enables first jaw 104 and second jaw 106 to be adjusted axially relative to the axis formed by elongated sleeve 120 and neck 110. The axial adjustment of jaw 104 and jaw 106 relative to one another correspondingly adjusts the axial or lateral extent of material receiving zone 130, as shown particularly in FIG. 4.

In this embodiment, first material contact assembly 116 of jaw 104 includes a material contact 140 which is laterally or axially adjustable for movement along the axis defined by the engagement of sleeve 120 and neck 110. In this embodiment, material contact 140 is made adjustable via a screw, collar and handle assembly 142.

In this embodiment, second material contact assembly 126 of jaw 106 includes a bracket 144 including two opposing contacts 146 extending transverse to the axis of second arm 124 and axially into material receiving zone 130. Bracket 144 is mounted to second arm 124 to enable pivoting motion of opposing contacts 146 within material receiving zone 130. The pivoting motion of bracket 144 also enables radially movement of contacts 146 with respect to the axis defined by elongated sleeve 120 and neck 110 when jaws 104 and 106 are engaged to one another.

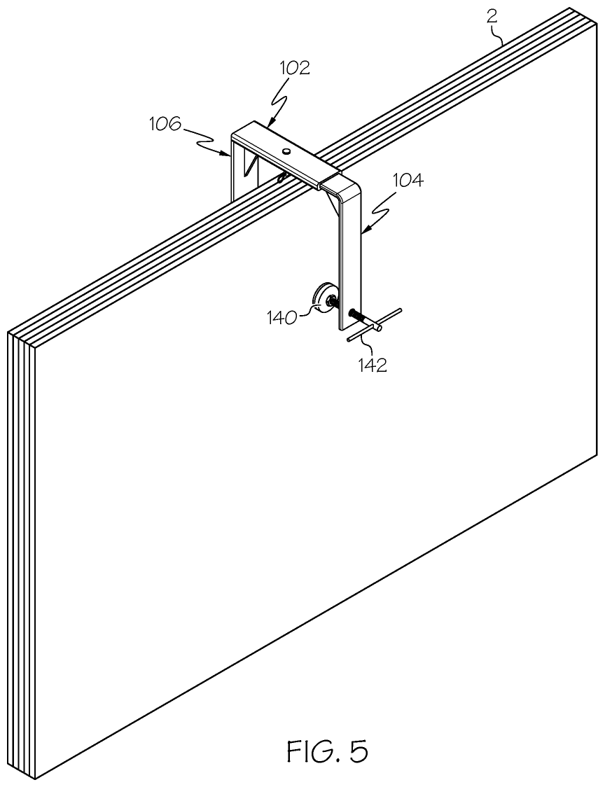

FIG. 5 illustrates material securing device 100 in operation in an embodiment wherein device 100 is used particularly to restrict lateral movement of sheets of material 2, such as slabs of stone. Device 100 is positioned so that portions of sheets of material 2 are within material receiving zone 130. Neck 110 is inserted within receiving channel 128 of sleeve 120 and engaged in the desired position by clevis pin 136 and hitch pin 138, thus securing jaws 104 and 106 to one another and defining an initial lateral extent of material receiving zone 130. Contacts 146 are positioned in contact with the sheets of material 2, with the pivoting motion of bracket 144 facilitating desirable contact between contacts 146 and sheets of material 2, including sheets of material 2 that may be supported or leaning in an angular position within material receiving zone 130. Material contact 140 may then be adjusted axially within the material receiving zone 130 until desirable contact force is applied to secure sheets of material 2 in zone 130 is achieved.

FIGS. 1 through 5 illustrate an example of one embodiment of the device 100 according to the invention. However, the invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

Thus, while exemplary apparatus, devices, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiment should not be considered as limiting of the scope of the invention in any way. Accordingly, the invention embraces alternatives, modifications and variations which fall within the spirit and scope of the invention as set forth herein, in the claims and any equivalents thereto.

I claim:

1. A securing device for stone and stone-like slabs comprising:
a generally C-shaped frame extending from a first distal end portion through a middle portion to a second distal end portion;
wherein the first distal end portion configurable to connect with a first bracing member;
wherein second distal end portion configurable to connect with a second bracing member.

2. The securing device for stone and stone-like slabs of claim 1 wherein the first bracing member comprises an elongated portion with a first and second bent tabs on opposing ends.

3. The securing device for stone and stone-like slabs of claim 1 further comprising a threaded nut aligned with an aperture defined by the second distal end portion through which a threaded rod having an inboard end and an outboard end is receivable for movement between a first retracted position and a second extended position.

4. The securing device for stone and stone-like slabs of claim 4 further comprising an engageable jaw attached to the inboard end of the threaded rod.

5. The securing device for stone and stone-like slabs of claim 5 wherein the engageable jaw comprises adjustable means.

6. The securing device for stone and stone-like slabs of claim 6 wherein the adjustable means include a ball joint.

7. The securing device for stone and stone-like slabs of claim 3 further comprising a handle connected to the outboard end.

8. The securing device for stone and stone-like slabs of claim 4 wherein the engageable jaw comprises engageable buffering material.

9. The securing device for stone and stone-like slabs of claim 1 wherein the generally C-shaped frame is configurable to separate into first and second bent sections respectively integral with the first and second distal end portions, and respectively further comprising first and second proximal end sections.

10. The securing device for stone and stone-like slabs of claim 9 wherein the first and second bent sections are mateable.

11. The securing device for stone and stone-like slabs of claim 10 wherein the first proximal end section forms a sleeve through which the second proximal end section is insertable.

12. The securing device for stone and stone-like slabs of claim 9 wherein first and second proximal end sections each define at least one bore alignable with one another.

13. The securing device for stone and stone-like slabs of claim 12 further comprising a lynchpin simultaneously insertable through a bore defined by each of the first and second proximal end sections.

14. The securing device for stone and stone-like slabs of claim 13 further comprising a cotter pin insertable through an at least one opening defined by the lynchpin.

15. The securing device for stone and stone-like slabs of claim 2 further comprising a threaded bolt shank integral with the first distal end portion and wherein the first bracing member defines a hole through which the bolt shank is insertable.

16. The securing device for stone and stone-like slabs of claim 15 further comprising a threaded wingnut engageable with the threaded bolt shank thereby retaining the first bracing member to the first distal end portion.

17. The securing device for stone and stone-like slabs of claim 9 further comprising a corner reinforcement piece integral with a corner defined by the first bent section.

18. The securing device for stone and stone-like slabs of claim 1 further comprising a side reinforcement piece integrated with the second distal end portion.

19. The securing device for stone and stone-like slabs of claim 18 wherein the side reinforcement piece comprises angle iron.

20. A securing device comprising:
first and second jaw members in a non-permanent engagement with one another, wherein the engagement is enabled for adjustment of the first and second jaw members in a plurality of positions, each position defining a lateral extent of a material receiving zone between the first and second jaw members;
a first material contacting member pivotally mounted on the first jaw member, wherein the material contacting member includes one or more material contacting surfaces configured to move in a transverse position relative to the lateral extent of the material receiving zone; and
a second material contacting member mounted on the second jaw member, wherein the material contacting member includes one or more material contacting surfaces configured to move in a lateral position within the material receiving zone.
